(19) United States
(12) Patent Application Publication
(10) Pub. No.: US 2004/0018869 A1
(43) Pub. Date: Jan. 29, 2004

(54) Symbol display device for game machine

(76) Inventor: Fumio Inoue, Tokyo (JP)

Correspondence Address: YOUNG & THOMPSON, 745 SOUTH 23RD STREET 2ND FLOOR, ARLINGTON, VA, 22202

(21) Appl. No.: 10/410,303

(22) Filed: Apr. 10, 2003

Related U.S. Application Data
(63) Continuation-in-part of application No. 10/161,678, filed on Jun. 5, 2002.

(30) Foreign Application Priority Data
Feb. 6, 2002 (JP) 2002-030023

(51) Int. Cl. G07F 17/34

(52) U.S. Cl. 463/20

(57) ABSTRACT

A symbol display device includes a stepping motor, a drive gear attached to a drive shaft of the stepping motor, a reduction gear meshing with the drive gear, and a reel fixed to the reduction gear. The stepping motor, the drive gear and the reduction gear are contained in the housing disposed in the reel. As a pitch radius of the reduction gear is set so as to be larger than that of the drive gear, a velocity of rotation of the reduction gear is lower than that of the drive gear. The stepping motor causes to rotate the reel with reduction of the rotational velocity.

### BACKGROUND OF THE INVENTION

1. Field of the Invention

The present invention relates to a symbol display device for a game machine, such as a pachinko machine, a slot machine and the like, and more particularly to an symbol display device for driving a stepping motor to rotate a reel whose periphery symbols are arranged on.

2. Description Related to the Prior Art

In a pachinko machine and a slot machine is well used a symbol display device having three reels whose periphery plural types of symbols are arranged on. In the symbol display device, each of the reels is attached to a drive shaft of a stepping motor.

In the pachinko machine, a ball enter in a start pocket, three reels start rotating, and thereafter automatically stop. Thereby, if symbols arranged on a judgment line form a winning combination, an attacker is opened for a predetermined time length. As the ball easily enters in the attacker, a player obtains many prize balls.

In the slot machine, after inserting several coins or tokens therein, the player operates a start lever to rotate the reels. When the player depresses a stop button, or the reels stop automatically. If symbols arranged on a judgment line form a winning combination, the player obtains many coins or tokens.

The pachinko machine or the slot machine is provided with a controller which controls a stopping position of the reels in order to arrange the same symbols on the judgment line at a predetermined probability. When the symbol display device drives, an inner lottery is made by using a random number generator, and the drive of the motor is controlled to fill the result of the lot. Accordingly, as the motor for driving the reel in the symbol display device, a stepping motor is used for easy controlling the stop position. The position of the reel is adjusted based on the number of the drive pulse supplied for the stepping motor.

Receiving a pulse signal, the stepping motor rotates a drive shaft attached thereto at a predetermined angle (thereafter unit-step angle). When receiving another pulse signal thereafter, the motor continues to rotate the drive shaft at the unit-step angle.

Just before the reel is stopped, a velocity of rotation of the stepping motor is made lower. In the stepping motor, when the unit stepping angle is larger, a time for the rotation at the unit step angle becomes longer. In this case, a difference of the rotational velocities between just before and after accepting the pulse signal is large, and the player can acknowledge that the reel does not smoothly spin and often finds it unnatural.

The problem will be solved when in the stepping motor the unit step angle is short. However, such a stepping motor is large and expensive as a reduction gear device is built in, and therefore hardly used in the symbol display device for the pachinko machine.

Further, Japanese Patent Laid-Open Publication No. 2001-224773 discloses an symbol display device in which a reduction gear having a large gear portion and a small gear portion is used. In the symbol display device, the large gear portion mashes with a drive gear of the stepping motor, and the small gear portion meshes with a gear attached through a shaft to a reel. The velocity of rotation becomes lower step by step, based on a ratio of pitch diameters between the drive gear and the large gear portion, between the large gear portion and the small gear portion, and between the small gear portion and the output gear. However, in this symbol display device, a wide space is necessary between the stepping motor and the reel for containing both of the large and small gear portions in the reduction gear. Therefore, the symbol display device hardly becomes thinner. Further, as many parts are used for producing the symbol display device, the cost for the production is high.

### SUMMARY OF THE INVENTION

An object of the present invention is to provide a symbol display device which is thinner.

Another object of the present invention is to provide a symbol display device whose cost for the production is low.

Still another object of the present invention is to provide an symbol display device for which a small number of parts are necessary that is easily assembled.

In order to achieve the object and the other objects, an symbol display device of the present invention has a reduction rotational member to which is fixed a reel whose periphery several symbols are arranged on. The reduction rotational member is connected with a drive rotational member attached on a drive shaft of a stepping motor, and a diameter of the reduction rotational member is larger than that of the drive rotational member. The stepping motor, the reduction rotational member, and the drive rotational member are contained in a housing.

In an preferred embodiment of the present invention, each of the drive rotational member and the reduction rotational member are a gear. In another embodiment of the present invention, the drive rotational member is a small pulley and the reduction rotational member is a large pulley.

According to the invention, the symbol display device becomes thinner. Further, as it has a small number of parts, the cost for the production becomes lower.

### BRIEF DISCRIPTION OF THE DRAWINGS

The above objects and advantages of the present invention will become easily understood by one of ordinary skill in the art when the following detailed description would be read in connection with the accompanying drawings:

FIG. 1 is a front view of a pachinko machine in which a symbol display device of the present invention is loaded;

FIG. 2 is a sectional exploded view of the symbol display device;

FIG. 3 is a cross-sectional view of the symbol display device;

FIG. 4 is a perspective view of a reduction gear;

FIG. 5 is a schematic diagram of a rotation transmitting mechanism;

FIG. 6 is a sectional exploded view of the second embodiment of the symbol display device;

FIG. 7 is a cross sectional view of the third embodiment of the symbol display device;

FIG. 8 is a cross sectional view of the forth embodiment of the symbol display device;

FIG. 8A is a plan view of a bearing supporter;

FIG. 9 is a cross sectional view of the fifth embodiment of the symbol display device.

FIG. 10 shows sixth embodiment of the symbol display device;

FIG. 11 is a perspective view showing a rear surface of the reduction gear in FIG. 10; and

FIG. 12 is a sectional view of the sixth embodiment.

### PREFERRED EMBODIMENTS OF THE INVENTION

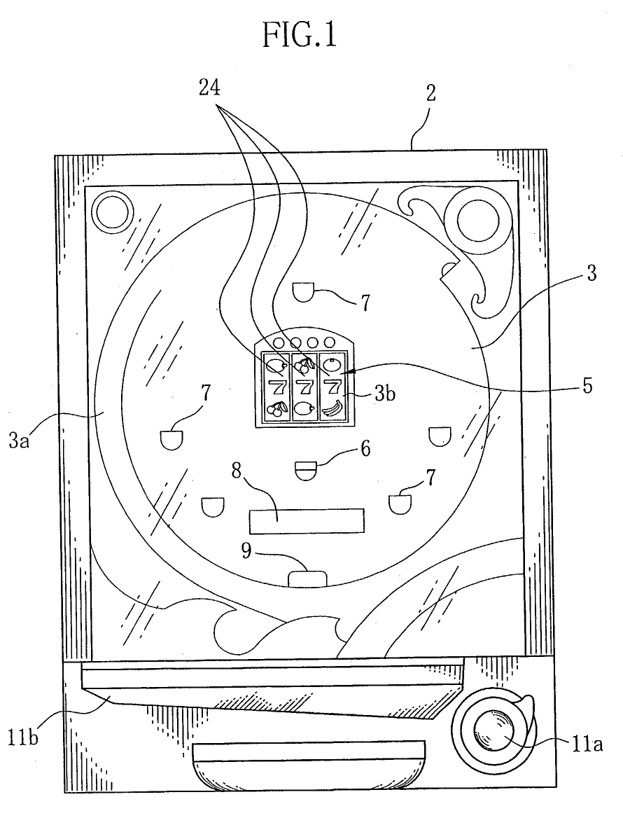

In FIG. 1, a pachinko machine 2 includes a playing surface 3, an symbol display device 5, a knob 11a and a loading stage 11b. On the playing surface 3, there are a passage 3a, a window 3b, a reel-start pocket 6, plural winning pockets 7, an attacker or open-close pocket 8, nails and pinwheels (not shown). Behind the reel-start pocket 6 and the plural winning pocket, the playing surface 3 has winning holes. Further, on the playing surface 3 are formed and a lost hole 9 and a special opening (not shown) which is opened and closed with the attacker 8.

The symbol display device 5 includes three reels 24 arranged one by one and is disposed behind the window 3b. As there are various symbols on each of the reels 24, nine symbols appear from the window 3b simultaneously. Note that the number of the reel may be also four and five.

In the loading stage 11b, balls (not shown) are loaded by a player. When the player rotate the knob 11 in a counterclockwise direction, a shooting device (not shown) is driven to shoot each of the balls. The ball passes through a passage 3a, and thereafter falls on the playing surface 3 to be captured by one of the reel-start pocket 6 and the winning pockets 7, or to enter in the lost hole 9. Further, when the attacker 8 opens the special winning opening, the ball may easily enter therein. The attacker 8, once it opens, is usually kept in open condition until the balls of a predetermined number (for example ten) enter in the special winning opening. Further, after the attacker is once closed, it opens again. The opening and closing the attacker 8 is repeated 16 times. When the ball enters in the winning holes or the special winning opening, 12 prize balls are supplied on the loading stage 11b in accordance to one winning ball.

Especially, when the ball enters in the reel-start pocket 6, the symbol display device 5 is driven. The three reels simultaneously start spinning, and thereafter stops. If a winning combination of the three symbols appear horizontally or diagonally on a line, for example “7-7-7”, the attacker 8 opens the special winning opening.

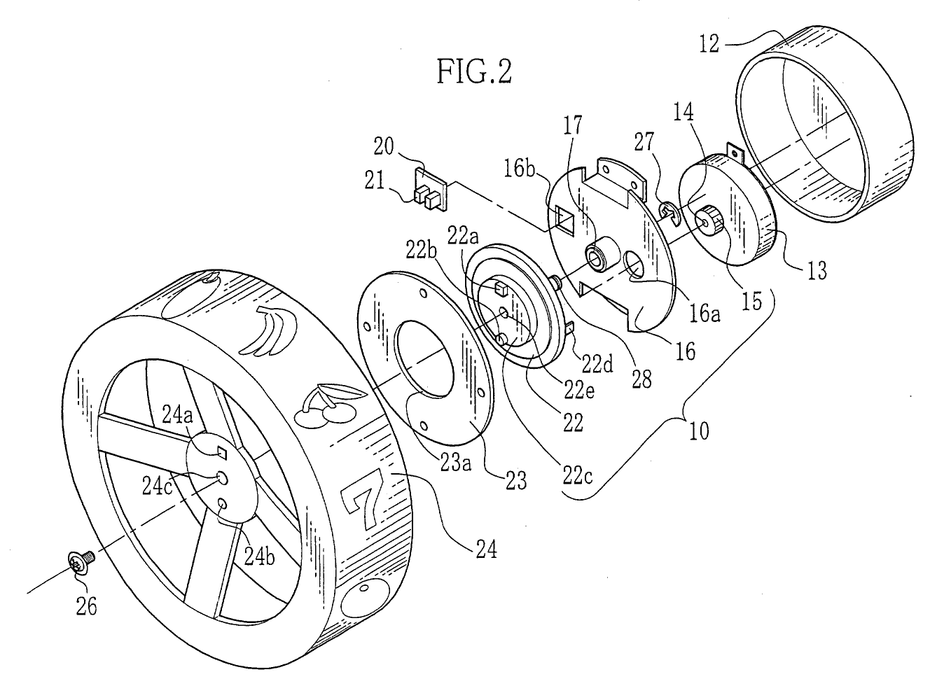

In FIG. 2 illustrating a reel unit, the rotation transmitting mechanism 10 is attached to the reel 24. The rotation transmitting mechanism 10 is constructed of a stepping motor 13, a drive gear 15, a disc-like plate 16, a reduction gear 22 and a E-shaped ring 27. On the reduction gear 22, a rotational shaft 28, a disk portion 22c and a light-shielding fragment 22d are formed. The disk portion 22c has a rectangular protuberance 22a and a pillar-like protuberance 22b and a screw hole 22e. The drive gear 15 is a plain gear and attached to a drive shaft 14 of the stepping motor 13. The drive gear 15 is rotatably fitted in a hole 16a formed in the disc-like plate 16 and meshes with an inner gear portion 22f (see FIG. 5) of the reduction gear 22. In a center of the shaft holder disc 16, a bearing 17 is provided. In the shaft holder 17 the rotational shaft 28 is inserted. On an end of the rotational shaft 28, the E-shaped ring 27 is attached to keep the rotational shaft 28 in the bearing 17.

Between the rotating transmitting mechanism and the reel 24, there is a cover 23 in which an aperture 23a is formed. In the aperture 23a is inserted the disk portion 22c of the reduction gear 22. A rectangular protuberance 22a and a cylindrical protuberance 22b of the disk portion 22c are respectively fitted in holes 24a and 24b formed in a center of the reel 24. The difference of the shapes between the rectangular protuberance 22a and the cylindrical protuberance 22b makes the reel 24 may be attached in a correct position. Further, the reel 24 has a screw hole 24c through which a screw 26 is inserted in a screw hole 22e of the reduction gear 22e such that the reel 24 may be fixed to the reduction gear 22.

The disk plate 16 has an opening 16b for disposing a photo sensor 21 attached to a base plate 20. On a rear face (not shown) of the base plate 20, parts for the photo sensor are fixed. As the parts are set in the opening 16b, edges of the rear face of the base plate 20 facially contact to the disk plate 16. Accordingly, the photo sensor 20 is disposed on the disk plate stably.

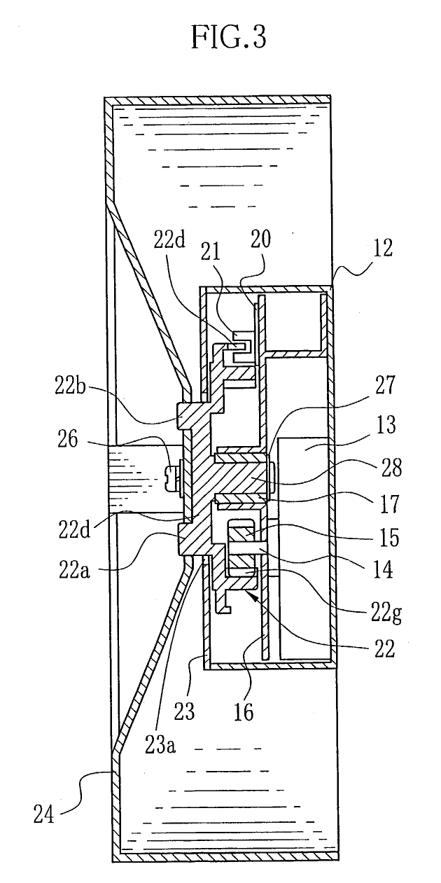

The photo sensor 21 includes a light projector and a light receiver (not shown). As shown in FIG. 3, the light-shielding fragment 22d of the reduction gear 22 passes in the photo sensor 21, and thereby shields a detection light projected from the light projector to the light receiver. Corresponding thereto, the photo sensor 20 generates a reel home position signal to send it to a controller (not shown) of the pachinko machine 2. The controller controls the stepping motor 13 based on the reel home position signal, so as to control a stop position of the reel 24.

As the light-shielding fragment 22d is provided not for the reel but for the reduction gear in order to detect the reel home position, the reel home position can be detect even when the reel 24 is removed. Further, the attachment of the dust on the sensor is prevented.

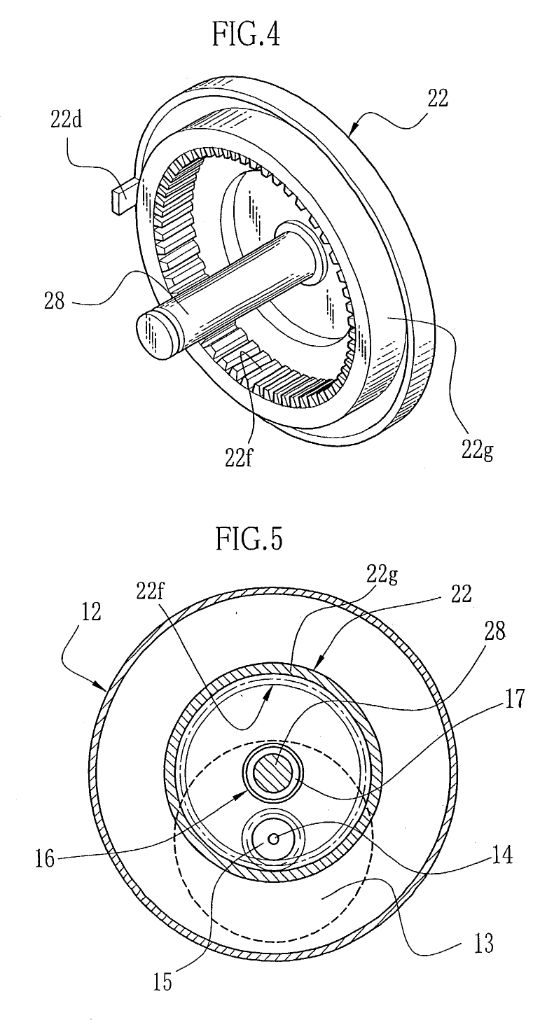

In FIG. 4, the reduction gear 22 has a cylindrical protrusion 22g. On an inner surface of the cylindrical protrusion 22g, an inner gear portion 22f is formed. The number of tooth of the inner gear 22f is larger than that of the drive gear 15. As shown in FIG. 5, a pitch diameter of the inner gear portion 22f is larger than that of the drive gear 15. Therefore, while the inner gear portion 22f meshes with the drive gear 15, the reduction gear 22 rotates more slowly than the drive gear 15. For example, supposed that the pitch diameter of the inner gear portion 22f would be four times larger than that of the drive gear 15, the stepping motor 13 rotates the drive gear 15 four times for rotating the reduction gear 22 once. Accordingly, the reel 24 rotates at a smaller angle than the unit step angle of the drive shaft 14 of the stepping motor 13. Therefore, even when the reel 24 rotates slowly, the rotation of the reel is smoothly.

The assembling of the reel unit will be explained now. The stepping motor 13 is fixed in the case 12. on the stepping motor 13 is set the disk plate 16 to which the photo sensor 21 is attached, and thereby the drive gear 15 is inserted in the hole 16a. The disc plate 16 is fixed in the case 12 by a screw (not shown). On the disc plate 16, the reduction gear 22 is superposed. Thereby, the inner gear 22f is meshed with the drive gear 15, and the rotational shaft 28 is inserted in the bearing 17.the cover 23 is fixed to the case 12 so as to cover the reduction gear 22. The case 12 and the cover 23 construct a housing. The disk plate 22c of the reduction gear 22 protrudes from the opening 23a of the cover 23. After setting the reel 24 to the disc plate 22c, the reel 24 is fixed to the screw 26. The housing is fixed to the frame of the pachinko machine. As the reel 24 is fixed to the reduction gear 23, the housing is not thick in a direction of the rotational shaft 28 so as to be contained in the reel 24.

The effect of the above pachinko machine will be described now. The player load the ball from the loading stage 11b in the pachinko machine 2. When the player rotate the knob 11a adequately in the clockwise direction, the balls pass through the passage 3a and fall on the playing surface 3 one after another. When the ball enters in the winning hole through the reel-start pocket 6, each of the stepping motor 13 drives the three reels 24 to spin, and thereafter the reels 24 automatically stop spinning. The reel 24 stops in the reduction of the rotational velocity of the stepping motor 13. Thereby, before and after the stepping rotation of the stepping motor 13, the difference of the rotational speed of the reel 24 is small such that the rotational speed of the reel 24 is reduced smoothly. Therefore, the player does not feet the reel spins curiously.

A number of the drive pulses necessary for rotating the reel 24 once is calculated from the unit step angle of the stepping motor 13 and the ratio of the pitch diameters between the drive gear 15 and the inner gear portion 22f. Accordingly, the controller can specify a rotational position of the reel 24 based on the number of the drive pulse supplied for the stepping motor 13 after receiving the reel home position signal. Furthermore, as the arrangement and the types of the symbols on the reel 24 is known based on the reel home position, the controller can also specify the types of the symbols which appear in the window 3b. The controller stops the reel 24 to set the symbols specified in the lottery in the window 3b. When the combination of the three symbols is a winning combination the attacker 8 opens, and the player can obtain the large number of balls.

In the embodiment above, the reduction gear 22g has the rectangular protuberance 22a and the pillar-like protuberance 22b. However, the shape and the number of such protuberances used for fixing to the reel 24 are not restricted. Further, in order to fix the reel 24 with the screw 26, a washer may be used. When the types or the arrangement of the symbols may be varied, the reel 24 can be changed to another one.

The light-shielding fragment 22d and the photo sensor 21 may be disposed in another positions different from embodiment shown in FIG. 3. Further, the photo sensor 21 maybe a reflection type.

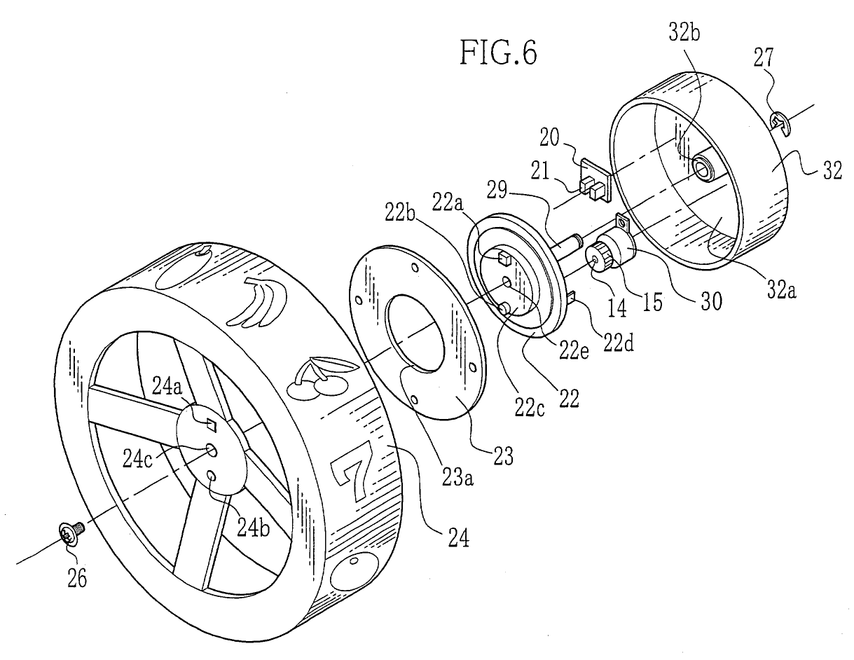

In the second embodiment of the present invention, as shown in FIG. 6, a stepping motor 30 and a case 32 are used, and the reduction gear 22g has a rotational shaft 29 which is longer than the rotational shaft 28 illustrated in FIG. 4. The rotational shaft 29 is rotatably supported by a bearing 37 which is provided with an inner surface 32 of the case 32. The base plate 20 to which the photo sensor 21 is attached is fixed on the inner surface 32a of the case 32. As the second embodiment does not have the base plate 16 of the first embodiment, the structure of the second embodiment is simple.

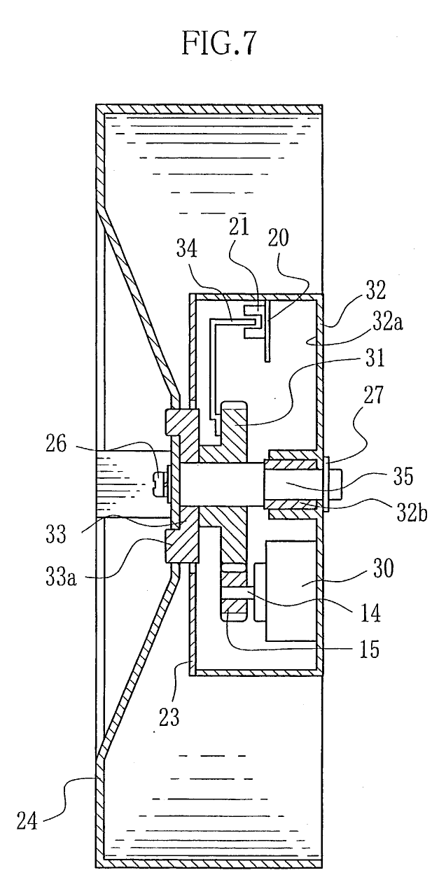

Further, as shown in FIG. 7, the symbol display device 5 may have a case 32 for containing a reduction gear 31 which has no inner gear portion but is a plain gear. The reduction gear 31 and a connect member 33 are fixed to a rotary shaft 35, and when the reduction gear 31 rotates, the rotary shaft 35 and the connect member 33 rotate integrally. The connect member 33 has projections 33a which is fitted and the reel 24 is fixed to the rotary shaft 35 with a screw 26. Further, a light-shielding fragment 34 is provided for the reduction gear 31 and detected by the photo sensor 21 in accordance with the rotation of the reduction gear 31.

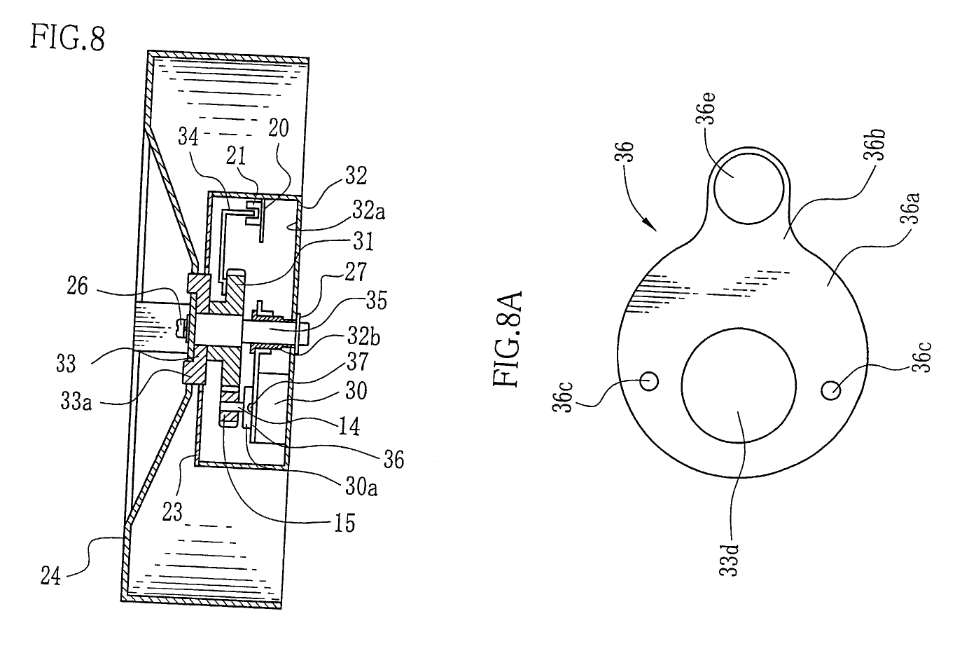

In an embodiment illustrated in FIG. 8, the bearing 32b is supported by a bearing holder plate 36. The bearing holder plate 36 is, as shown in FIG. 8A, constituted of a disk portion 36a and a protruding portion 36b formed with the disk portion 36a. The disc portion 36a has holes 36c for inserting the screws 37 therein and an opening 36d for inserting the protruding part 30a of the stepping motor 30. In the protruding portion 36b an opening 36e is formed. The opening 36e is fixedly fitted on the bearing 32b. The bearing holder plate 36 is fixed with the screws 37 to the stepping motor 30 which is fixedly disposed on the inner surface 32a of the case 32. Note that the bearing holder plate 36 may be fixed to the stepping motor 30 by welding and the like. Further, the bearing holder plate 36 may be disposed on a bottom of the stepping motor 30. Furthermore, on the inner surface 32a of a bottom of the case 32, a protruding may be formed such that the protruding and the bearing holder plate 36 may support the bearing 32b.

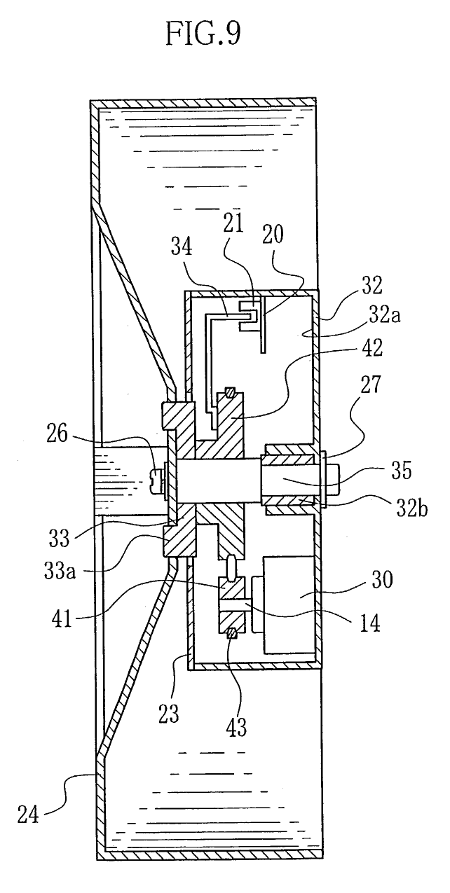

In FIG. 9, a small pulley 41 is attached to the drive shaft 14 of the stepping motor 30. The small pulley 41 is connected through a belt 43 to a large pulley 42 attached to the rotary shaft 35. When the stepping motor 30 is driven, the small pulley 41 is rotated. The rotation of the small pulley 41 is transmitted through the belt 43 to the large pulley 42, and then the reel 24 rotates. As the large pulley 42 has a larger diameter than the small pulley 41, the rotational velocity of the reel 24 is reduced in accordance with a ratio between radiuses of the large and small pulleys 41, 42. Note that in FIG. 8 the same structure as in FIG. 7 has the same number, and the explanations therefore are not made.

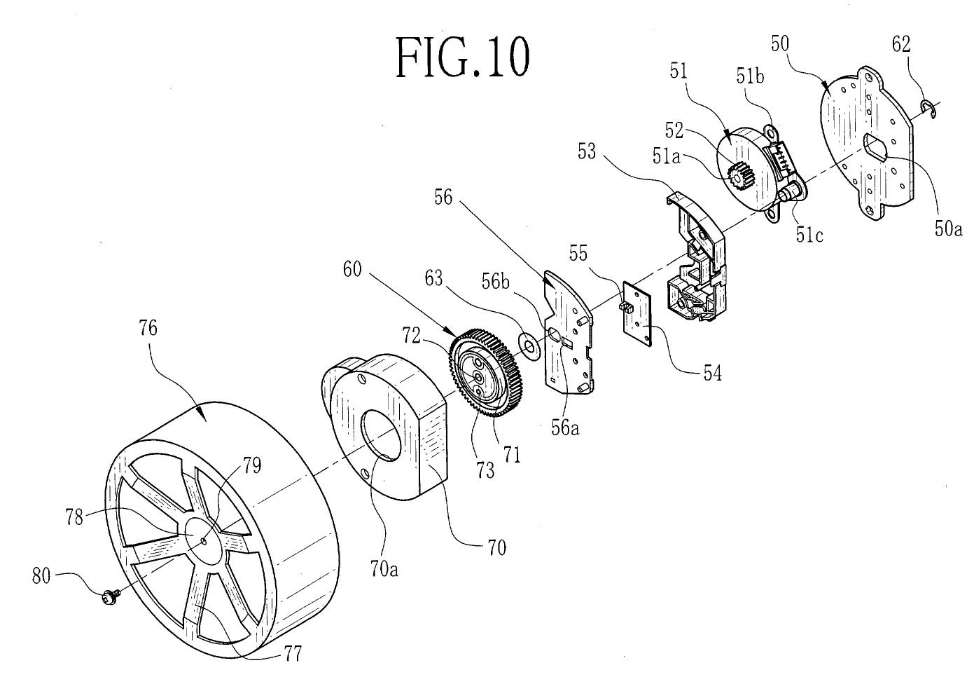

FIGS. 10-12 shows the embodiment of providing plural light-shielding fragments and detecting plural specified positions of the reel while the reel is rotated one revolution. A stepping motor 51 is fixed on a base plate 50. The stepping motor 51 has a drive shaft 51a on which a drive gear 52 is fixed. A motor base 51b is provided with a bush 51c.

A sensor box 53 is attached to the base plate 50, in addition to the stepping motor 51. A sensor plate 54 is attached to the sensor box 53. A photo sensor (photo interrupter) 55 is provided on the sensor plate 54. Codes (not shown) which are respectively connected with the stepping motor 51 and the photo sensor 55 are arranged in the sensor box 53. In front of the sensor box 53, a cover 56 is attached so as to cover the sensor plate 54 and the codes. The photo sensor 55 is protruded from a hole 56a of the cover 56. In FIG. 12, the sensor box 53 and the cover 56 are omitted.

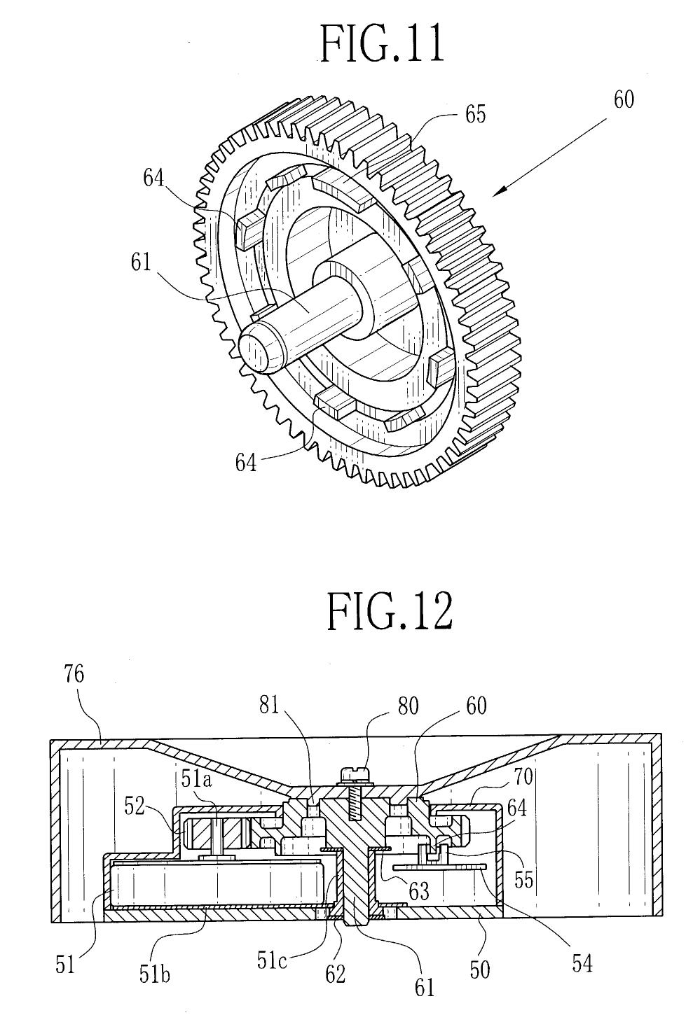

There is disposed a reduction gear 60 in front of the cover 56. A diameter of the reduction gear 60 is larger than that of the drive gear 52 such that a rotational velocity of the stepping motor 51 is reduced. As shown in FIG. 11, the reduction gear 60 is provided with a gear shaft 61 protruding toward the base plate 50, and the gear shaft 61 passes through the hole 56b of the cover 56, and rotatably supported by the bush 51c of the motor base 51b. Furthermore, an end of the gear shaft 61 penetrates through a long hole 50a of the base plate 50. An E-shaped ring 62 is fitted in the end of the gear shaft 61, in order to prevent the gear shaft 61 from removing from the long hole 50a. A washer 63 is fitted in the gear shaft 61 so as not to contact the reduction gear 60 with the cover 56 directly.

In a rear side of the reduction gear 60, six narrow light-shielding fragments (indexes) 64 and one wide light-shielding fragment are provided on concentric circles at regular pitch. A passing of these light-shielding fragments 64 and 65 is detected optically by the photo sensor 55. The light-shielding fragment 65 is used for detecting a home position, and when the light-shielding fragment 65 passes in the photo sensor 55, wide pulse is outputted from the photo sensor 55.

Upon assembling a reel unit, the stepping motor 51 and the sensor box 53 are attached onto the base plate 50. And then, the cover 56 is fixed to the sensor box 53, and the reduction gear 60 is disposed. A case 70 is covered on the reduction gear 60, and fixed to the base plate 50 with a screw and the like, to complete the reel unit. The base plate 50 and the case 70 construct a housing.

A hole 70a is formed in the case 70, and a protruding portion 71 formed in a front side of the reduction gear 60 is fitted rotatably. In the protruding portion 71, the center part thereof has a screw hole 72, and the periphery thereof is provided with two holes 73 having different sizes.

A reel 76 has a cylindrical shape, and plural symbols (not shown) are drawn on the periphery thereof. Plural arms 77 are radially provided in one end of the reel 76, and a hub 78 is formed in an intersection of the arms 77. A hole 79 is formed in a center of the hub 78. A screw 80 penetrating the hole 79 is screwed with the screw hole 72 of the reduction gear 60 so that the reel 76 is fixed to the reduction gear 60. As shown in FIG. 12, two pins 81 having different sizes are provided in the reel 76. These pins 81 are respectively fitted into the corresponding holes 79 of the reduction gear 60, so that the relative position between the reel 76 and the reduction gear 60 is determined.

In the reel unit, a signal is outputted from the photo sensor 55 every 1/7 revolution of the reel 76 with reduction gear 60, so that the rotational position of the reel 76 is detected. Accordingly, even if the stepping motor 15 is dropped off, a correct position of the reel 76 can be obtained by 1/7 revolution. In addition, the home position of the reel 76 is obtained by detecting the light-shielding fragments 65 with the reel 76. Further, since the light-shielding fragments 64 and 65 and the photo sensor 55 are contained in the housing, dust and dirt are not adhered to them, so that lowering of the detecting accuracy can be prevented.

Seven light-shielding fragments may be arranged at different pitch, and the number of the light-shielding fragments may be decided arbitrarily. The two types of light-shielding fragments can be identified by various methods. For example, two light-shielding fragments arranged adjacently are used for detecting the home position, and on the contrary, one light-shielding fragment is used for detecting the specified position. Moreover, the light-shielding fragment for detecting the home position and the light-shielding fragment for detecting the specified position have the same shape. In such a case, if the pitch of the home position sensing the light-shielding fragment is changed against the specified light-shielding fragments so as to identify the two types of light-shielding fragments.

Further, the symbol display device of the present invention may be used in other game machine, for example a slot machine and the like.

Various changes and modifications are possible in the present invention and may be understood to be within the present invention.

What is claimed is:

1. An symbol display device having a reel on whose periphery plural symbols are arranged, a stepping motor for rotating a reel, a rotation transmitting mechanism for transmitting a rotation of said stepping motor to said reel, said rotation transmitting mechanism comprising:
a first rotational member attached to said stepping motor;
a second rotational member for rotating said reel, a diameter of said second rotational member being larger than that of said first rotating member such that a rotational velocity may be reduced; and
a housing containing said stepping motor, said first rotating member and said second rotating member and rotatably holding said second rotational member, said housing being disposed in said reel.

2. An symbol display device as claimed in claim 1, wherein said first rotational member is a drive gear, and said second rotational member is a reduction gear.

3. An symbol display device as claimed in claim 2, further comprising:
a partition plate for separating an inside of said housing,
wherein said reduction gear is rotatably attached to said partition plate, a part of said reduction gear protrudes from an opening of said housing, and said reel is attached to said part.

4. An symbol display device as claimed in claim 3, wherein said reduction gear has an inner gear portion meshed with said drive gear.

5. A symbol display device as claimed in claim 2, further comprising:
a rotational shaft, rotatably attached to said housing, for holding said reduction gear; and
a connect member for holding said reel, said connect member being formed with said reduction gear.

6. A symbol display device as claimed in claim 5, further comprising:
a bearing for rotatably supporting said rotational shaft, an first end of said bearing being fixed to said housing; and
a bearing holder plate having an opening that is fixed to said stepping motor, said opening being rigidly fitted to an second end of said bearing.

7. A symbol display device as claimed in claim 2, wherein said first rotational member is a small pulley, said second rotational member is a large pulley, and said large pulley is connected through a belt with said small pulley.

8. A symbol display device as claimed in claim 7, further comprising:
a rotational shaft for holding said large pulley, said rotational shaft being rotatably attached to said housing; and
a connect member for holding said reel, said connect member being fixed to said rotational shaft.

9. A symbol display device as claimed in claim 1, further comprising:
a light-shielding fragment attached to said second rotational member;
a photo sensor fixed in said housing, said photo sensor detecting a passing of said light-shielding member in order to detect a home position of said reel.

10. A symbol display device having a reel on whose periphery plural symbols are arranged, a stepping motor for rotating a reel, a rotation transmitting mechanism for transmitting a rotation of said stepping motor to said reel, said rotation transmitting mechanism comprising:
a first rotational member attached to said stepping motor;
a second rotational member for rotating said reel, a diameter of said second rotational member being larger than that of said first rotating member such that a rotational velocity may be reduced;
a housing containing said stepping motor, said first rotating member and said second rotating member, said housing rotatably holding said second rotational member and being disposed in said reel;
plural light-shielding fragments attached to said second rotational member; and
a photo sensor fixed in said housing, said photo sensor detecting a passing of one of said light-shielding members in order to detect a rotational position of said reel.

11. A symbol display device as claimed in claim 10, wherein said first rotational member is a drive gear, and said second rotational member is a reduction gear.

12. A symbol display device as claimed in claim 11, wherein said plural light-shielding fragments are a wide light-shielding fragment and plural narrow light-shielding fragments, and said wide light-shielding fragment is used for specifying a home position of said reel.
